(19) United States
(12) Patent Application Publication
(10) Pub. No.: US 2008/0209823 A1
(43) Pub. Date: Sep. 4, 2008

(54) Modular window well

(76) Inventor: Dan H. Gernstein, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/152,048

(22) Filed: May 12, 2008

Related U.S. Application Data
(63) Continuation-in-part of application No. 11/786,708, filed on Apr. 12, 2007.
Application No. 11/786,708 is a continuation-in-part of application No. 11/598,344, filed on Nov. 13, 2006.

(51) Int. Cl. E06B 5/02; E04B 1/348

(52) U.S. Cl. 52/107

(57) ABSTRACT

A modular window well for use by a person to escape through a window formed in a basement wall including a generally U-shaped body member having upper and lower ends and inner and outer ends. The open upper end of the body member has a spacer and a removable lid mounted thereon. The body member is comprised of a composite material such as fiberglass. A stair structure is positioned adjacent the inner surface of the front wall of the body member and is also comprised of a composite material.

### CROSS-REFERENCE TO RELATED APPLICATION

This is a continuation-in-part application of Petitioner's earlier application Ser. No. 11/786,708, filed Apr. 12, 2007, entitled “WINDOW WELL” which is a continuation-in-part application of Petitioner's earlier application Ser. No. 11/598,344 filed Nov. 13, 2006, entitled “WINDOW WELL”.

This application also claims the benefit of U.S. Provisional Application Ser. No. 60/849,709 entitled “WINDOW WELL” filed Oct. 5, 2006, the disclosure of which is hereby incorporated herein by reference.

### BACKGROUND OF THE INVENTION

1. Field of the Invention

This invention relates to a window well and more particularly to a window well which provides an emergency escape structure from a basement window. Even more particularly, the window well of this invention includes a stair structure which is positioned at the inside surface of the back wall thereof to assist a person to climb upwardly and outwardly from the interior of the window well.

Even more particularly, the window well of this invention relates to a modular window well comprised of several modules which may be joined together to form various width window wells.

2. Description of the Related Art

Many city or municipal codes require that if a bedroom is located in a basement, there must be some means of escape from the bedroom. In the past, it is believed that large window wells have been provided which do provide a means of escaping from a basement bedroom window with the same being constructed of timbers, ties, concrete blocks, etc. It is believed that the prior art structures are difficult to build or construct, are not aesthetically pleasing in appearance, are not durable, and do not have a cover at the top thereof which prevents debris from accumulating in the window well.

Further, it is believed that none of the prior art window wells has a stair structure associated therewith which may be used by a person to climb upwardly and outwardly from the interior of the window well.

Although the window wells of the co-pending applications function extremely well, the window wells of the co-pending applications are not comprised of modules which may be joined together to form window wells having different egress widths.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In a first embodiment, the modular window well of this invention comprises an upstanding first side wall module having an upper end, a lower end, a first side edge, a second side edge, an inner surface and an outer surface; an upstanding first corner radius module having an upper end, a lower end, a first side edge, a second side edge, an inner surface and an outer surface; an upstanding second side wall module having an upper end, a lower end, a first side edge, a second side edge, an inner surface and an outer surface; and an upstanding second corner radius module having an upper end, a lower end, an inner surface and an outer surface. In the first embodiment, the second side edge of the first side wall module is joined to the first side edge of the first corner radius module and the second side edge of the first corner radius module is joined to the second side edge of the second corner radius module and the second side edge of the second side wall module is joined to the first side edge of the second corner radius. The first embodiment provides an egress width which may be 39 inches.

In a second embodiment, an upstanding first back wall module is provided which has an upper end, a lower end, a first side edge, a second side edge, an inner surface and an outer surface. In the second embodiment, the first back wall module is positioned between the second side edge of the first corner radius module and the second side edge of the second corner radius with its side edges being joined to the second side edges of the first and second corner radius modules to create a window well having an egress width greater than in the first embodiment. Other embodiments may be provided by substituting back wall modules having greater widths to provide greater egress widths.

In all of the embodiments, a stair structure is preferably positioned within the window well. Preferably, in all embodiments, a cover/spreader module is utilized which extends between the upper ends of the side wall modules. The cover/spreader module maintains the Window Well in its desired configuration. A transparent or translucent cover module is positioned on the upper ends of the modules outwardly of the cover/spreader module. The cover module permits light to pass therethrough into the interior of the window well.

The cover module and the cover/spacer module prevent debris from accumulating in the window well. The cover module is removable from inside the window well by simply pushing upwardly thereagainst.

A pan module or floor module is positioned at the lower end of the window well and is secured to the module thereabove by stainless steel fasteners such as bolts and nuts.

In all embodiments, the side wall modules, the back wall module and the corner radius modules are secured together by screws or bolts.

The modules, with the exception of the cover module are comprised of a composite material such as reinforced fiberglass having a gel coat thereon which is heated to prevent the material from fading.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of the first embodiment of window well of this invention with a spacer and lid mounted thereon;

FIG. 2 is a front perspective view of another embodiment of the window well of this invention;

FIG. 3 is an exploded perspective view of various modules which may be joined together to form window wells having different egress widths;

FIG. 4 is a top view of the first embodiment of this invention with the cover/spreader and cover modules removed therefrom;

FIG. 5 is a top view of a second embodiment of this invention with the cover/spreader and cover modules removed therefrom; and

FIG. 6 is a top view of a third embodiment of this invention with the cover/spreader and cover modules removed therefrom.

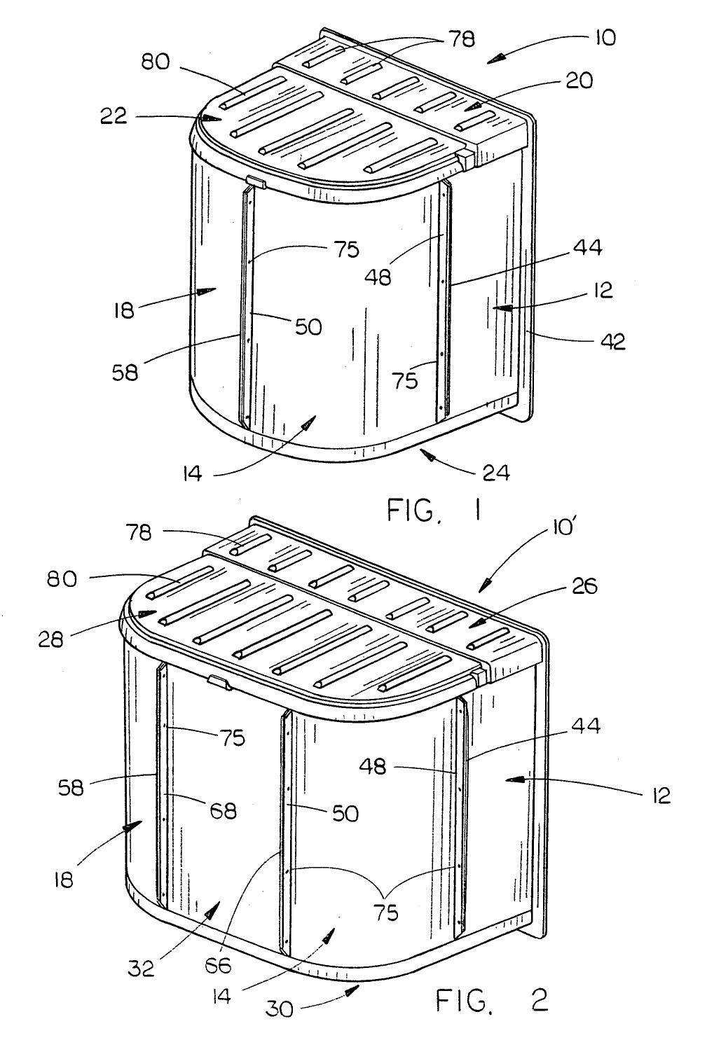

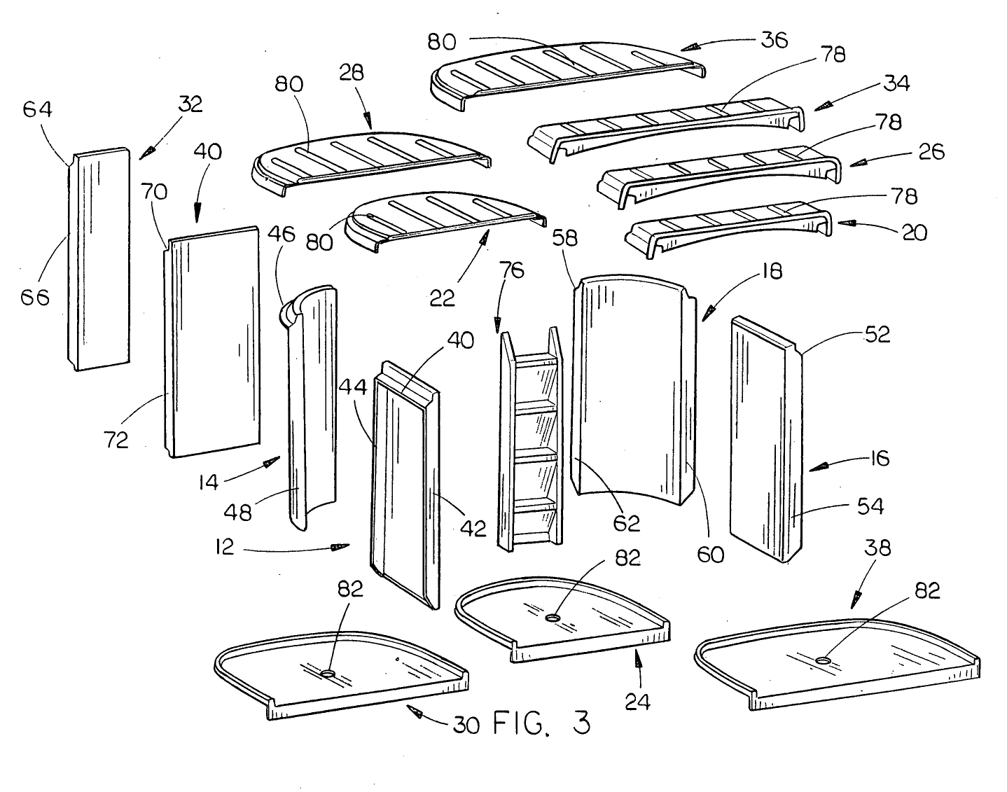

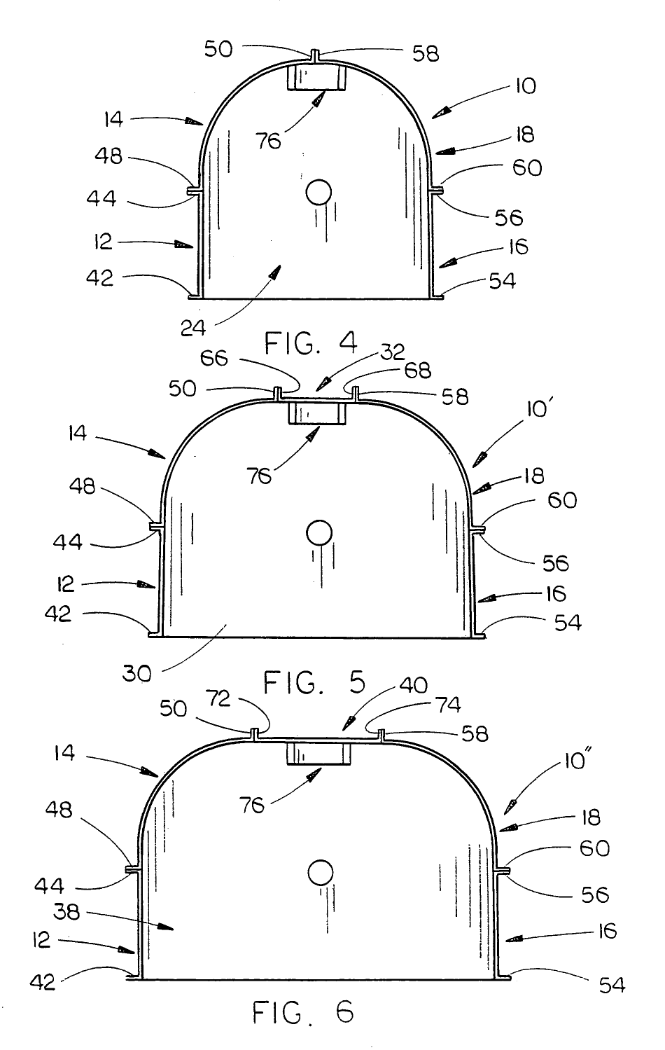

### DETAILED DESCRIPTION OF THE DRAWINGS

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

In the drawings, the numerals 10, 10′ and 10″ refer to three different embodiments of the modular window well of this invention. Window well 10 is comprised of a first sidewall module 12, a first corner radius module 14, a second sidewall module 16, a second corner radius module 18, a first cover/spreader module 20, a first cover module 22, and a first bottom pan module 24.

Window well 10′ is comprised of first sidewall module 12, first corner radius module 14, second sidewall module 16, second corner radius module 18, a second bottom pan module 30, and a back wall module 32.

Window well 10″ is comprised of first sidewall module 12, first corner radius module 14, second sidewall module 16, second corner radius module 18, a third cover/spreader module 34, third cover module 36, bottom pan 38, and back module 40 which is substituted for back wall 32.

Sidewall module 12 includes an upper flange 40 which extends outwardly therefrom below the upper end thereof. Module 12 also includes a first side edge flange 42 and second side edge flange 44 which also extend outwardly from the module 12.

Module 14 includes an upper flange 46 which extends outwardly therefrom below the upper end thereof, a first side edge flange 48 and a second side edge flange 50 which also extend outwardly therefrom as illustrated in the drawings.

Module 14 includes an upper flange 46 which extends outwardly therefrom below the upper end thereof, a first side edge flange 48 and s second side edge flange 50 which also extend outwardly from the module 14.

Module 16 includes an upper flange 52 which extends outwardly therefrom below the upper ends thereof, a first side edge flange 54 and a second side edge flange 56 which also extend outwardly from the module 16.

Module 18 includes an upper flange 58 which extends outwardly therefrom below the upper ends thereof, a first side edge flange 60 and a second side edge flange 62 which also extend outwardly from the module 18.

Back wall module 32 includes an upper flange 64 which extends outwardly therefrom below the upper end thereof, a first side edge flange 66 and a second side edge flange 68 which also extend outwardly from the module 32.

Back wall module 40 includes an upper flange 70 which extends outwardly therefrom below the upper end thereof, a first side edge flange 72 and a second side edge flange 74 which also extend outwardly from the module 40.

The side edge flanges of the various modules are secured together by stainless steel bolts 75 which extend through the adjacent flanges thereof. Although it is preferred that the flanges be bolted together, they could be glued together or secured together by other means if so desired. Although the flanges on the modules are disclosed as being a fiberglass material, they could also be metal imbedded in fiberglass material.

Egress width of the window well is easily changed by substituting or adding a back wall 32 or a back wall 40. When neither of the back walls 32 or 40 are being utilized, the cover/spreader 20 will be positioned over the upper ends of the sidewall modules 12 and 16 in the same manner as described in the co-pending application and the transparent or translucent cover module 32 will be extended over the outer ends of the modules 12 and 16 as well as the corner radius modules 14 and 18. The stair structure 76 will be positioned within the window well so as to be positioned against the corner radius modules 14 and 18 as illustrated in FIG. 4.

If it is desired to increase the egress width of the window well from 39 inches to 57 inches, the back wall module 32 will be positioned between the corner radius modules 14 and 18 and secured thereto to increase the egress width from 39 inches to approximately 57 inches. In that situation, the cover/spreader 26 and the cover 28 will be utilized. If it is desired to further increase the egress width of the window well, the back wall module 40 will be substituted for the back wall module 32 and will be positioned between the corner radius modules 14 and 16 and secured thereto. In that case, the cover/spreader 34 will be utilized as will the cover 36.

Preferably, the height of the window well is between 48 inches and 60 inches with the width between the side portions being from 39 inches to 75 inches. Preferably, the modules 12, 14, 16, 18, 32 and 40 are comprised of a fiberglass material as are the cover/spreaders 20, 26 and 34. Preferably, the covers 22, 28 and 36 are comprised of a translucent or transparent material to permit light to enter the interior of the window well. Preferably, the cover/spreaders 20, 26 and 34 are provided with re-enforcing ribs 78 while the cover modules 22, 28 and 36 are provided with re-enforcing ribs 80 as illustrated in the drawings.

The cover/spreaders 20, 26 and 34 ensure that the sidewall modules 12 and 16 may not move towards one another or move away from one another. The cover/spreaders are preferably glued or otherwise secured to the upper ends of the modules as described. Preferably, each of the bottom pans 24, 30 and 38 are secured to the lower ends of the mating modules by glue or the like or stainless steel rivets or bolts. Preferably, the bottom pans 24, 30 and 38 are provided with openings 82 formed therein to permit water to drain from the interior of the window well structure. The flanges 42 and 54 of the modules 12 and 16 are secured to the exterior surface of the basement wall by rivets, bolts, anchors, glue or double faced tape.

In the event that a person must escape from the house during a fire or the like, the person will open the basement window and enter the interior of the window well. The person would push upwardly on the cover 22, 28 or 36 so that the person may climb out of the window well through the open upper end of the window well by utilizing the stair structure 76.

Not only is the window well of this invention easy to ship, since it is in modular form, but it easy to install on the basement wall. The window well of this invention is readily adapted to have different egress widths through the utilization of different back walls, bottom pans, cover/spreaders and covers.

Normally, the window well 10 will be installed or mounted on the exterior surface of the basement wall prior to backfilling with the interior of the window well 10 being in communication with a basement window. Should water somehow enter the interior of the window well 10, it may drain therefrom through the drain opening formed in the bottom pan. Regardless of pressures within the ground such as may be created by backfill or water, the cover/spreader maintains the shape of the window well 10. Normally, the cover will be installed on the window well so as to prevent debris from entering the window well. The translucent characteristic of the cover enables sunlight to pass therethrough to permit light to enter the basement window.

In the event that a person must escape from the house during a fire or the like, the person will open the basement window and enter the interior of the window well 10. The person will push upwardly on the cover so that the person may climb out of the window well through the open upper end of the window well 10 by utilizing the stair structure 76 which not only provides steps but handholds as well.

Not only is the window well 10 of this invention easy to ship, but it is easy to install on the basement wall. A certain amount of the upper portion of the window well 10 will be exposed above the ground surface and the fiberglass composition of the window well will be aesthetically pleasing.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A modular egress window well for use by a person to escape through a window formed in a basement wall, comprising:
a first upstanding side wall module having an upper end, a lower end, a first side edge, a second side edge, and inner and outer surfaces;
a first upstanding curved corner module having an upper end, a lower end a first side edge, a second side edge and inner and outer surfaces;
a second upstanding side wall module having an upper end, a lower end, a first side edge, a second side edge and inner and outer surfaces;
a second upstanding curved corner module having an upper end, a lower end, a first side edge, a second side edge and inner and outer surfaces;
said second side edge of said first side wall module being joined to said first side edge of said first corner module;
said second side edge of said second side wall module being joined to said first side edge of said second corner module;
said second side edges of said first and second corner modules being joined together whereby the joined modules define a generally U-shaped body member;
said modules being comprised of a composite material.

2. The modular egress window well of claim 1 wherein a spacer member module is secured to said upper ends of said first and second side wall modules adjacent said first side edges thereof and extending therebetween to prevent relative movement therebetween and wherein a lid is removably positioned on said upper ends of said first and second corner modules and said first and second side wall modules outwardly of said spacer.

3. The modular egress window well of claim 1 wherein said composite material comprises a fiberglass material.

4. the modular egress window well of claim 2 wherein said lid is translucent.

5. The modular egress window well of claim 2 wherein said spacer is comprised of a composite material.

6. The modular egress window well of claim 5 wherein said spacer has reinforcing ribs formed thereon.

7. The modular egress window well of claim 1 further including an upstanding stair structure positioned at said inner surfaces of said corner modules adjacent said second side edges thereof.

8. The modular egress window well of claim 7 wherein said stair structure is comprised of a composite material.

9. A modular egress window well for use by a person to escape through a window formed in a basement wall, comprising:
a first upstanding side wall module having an upper end, a lower end, a first side edge, a second side edge, and inner and outer surfaces;
a first upstanding curved corner module having an upper end, a lower end a first side edge, a second side edge and inner and outer surfaces;
a second upstanding side wall module having an upper end, a lower end, a first side edge, a second side edge and inner and outer surfaces;
a second upstanding curved corner module having an upper end, a lower end, a first side edge, a second side edge and inner and outer surfaces;
an upstanding back wall module having an upper end, a lower end, a first side edge, a second side edge, and inner and outer surfaces;
said second side edge of said first side wall module being joined to said first side edge of said first corner module;
said second side edge of said second side wall module being joined to said first side edge of said second corner module;
said second side edge of said first corner module being joined to said first side edge of said back wall module;
said second side edge of said second corner module being joined to said second side edge of said back wall module;
said modular being joined together whereby the joined modules define a generally U-shaped body member;
said modules being comprised of a composite material.

10. The modular egress window well of claim 9 wherein said back wall module may have varying widths between its side edges to enable the U-shaped body member to have varying widths.

11. The modular egress window well of claim 9 wherein a spacer member module is secured to said upper ends of said first and second side wall modules adjacent said first side edges thereof and extending therebetween to prevent relative movement therebetween and wherein a lid is removably positioned on said upper end of said back wall module, said upper ends of said corner modules and said first and second side wall modules outwardly of said spacer.

12. The modular egress window well of claim 11 wherein said spacer is comprised of a composite material.

13. The modular egress window well of claim 11 wherein said lid is comprised of a translucent material.

14. The modular egress window well of claim 9 wherein an upstanding stair structure is positioned at said inner surface of said back wall module.

15. The modular egress window well of claim 14 wherein said stair structure is comprised of a composite material.
